(19) United States
(12) Patent Application Publication
(10) Pub. No.: US 2010/0195961 A1
(43) Pub. Date: Aug. 5, 2010

(54) OPTICAL TRANSCEIVER WITH METAL SHIELD

(75) Inventor: Satoshi YOSHIKAWA, Yokohama-shi (JP)

Correspondence Address: VENABLE LLP, P.O. BOX 34385, WASHINGTON, DC, 20043-9998, US

(73) Assignee: Sumitomo Electric Industries, Ltd., Osaka-shi (JP)

(21) Appl. No.: 12/695,283

(22) Filed: Jan. 28, 2010

(30) Foreign Application Priority Data
Feb. 4, 2009 (JP) 2009-023641

(51) Int. Cl. G02B 6/36

(52) U.S. Cl. 385/92

(57) ABSTRACT

An optical transceiver with the optical receptacle tightly assembled with the optical subassemblies is disclosed. The optical transceiver provides a metal shield. The optical subassembly provides a pair of flanges and a neck between the flanges. The metal shield has a cut with the U-shape and a rib formed along the edge of the U-shaped cut. The metal shield is put between the flange and the optical receptacle so as to crush the rib, which causes a repulsive force against the flange to set the optical subassembly on the optical receptacle without loose.

### CROSS REFERENCE TO RELATED APPLICATIONS

The present application is closed related to the following commonly assigned U.S. patent application: Ser. No. 11/242,148, entitled by “HEAT DISSIPATING MECHANISM OF A PLUGGABLE OPTICAL TRANSCEIVER”, now issued as U.S. Pat. No. 7,416,353; and Ser. No. 11/656,003, entitled by “OPTICAL TRANSCEIVER WITH A PLUGGABLE FUNCTION”, now issued as U.S. Pat. No. 7,406,230, which are incorporated herein by references in their entirety.

### BACKGROUND OF THE INVENTION

1. Field of the Invention

The present invention relates to an optical transceiver, in particular, the invention relates to an arrangement for the EMI shielding in a pluggable

2. Related Background Art

One type optical transceiver provides a transmitter optical subassembly (hereafter denoted as TOSA) and a receiver optical subassembly (ROSA) each having, what is called, a coaxial package and being assembled with an optical receptacle. Such a TOSA and a ROSA has a tubular sleeve with a pair of flanges and a neck between the flanges. While, the optical receptacle has a U-shaped saddle in a rear end thereof. Mounting the neck of the sleeve on the saddle, the TOSA and the ROSA are assembled with the optical receptacle.

A width of the neck of the sleeve between the flanges is generally greater than a width of the saddle of the receptacle; accordingly, only mounting the neck on the saddle, the sleeve is rather loose on the saddle. The present invention may provide an optical transceiver with the co-axial TOSA and the co-axial ROSA tightly mounted on the optical receptacle.

### SUMMARY OF THE INVENTION

An optical transceiver of the present invention comprises an optical subassembly, an optical receptacle and a metal shield. The optical transceiver has a co-axial CAN package and a sleeve. The sleeve has a pair of flanges and a neck between the flanges. A feature of the present optical transceiver is that the metal shield has a U-shaped cut with a rib formed along this U-shaped cut, and this metal shield is put between one of the flanges of the optical subassembly and the optical receptacle such that the metal shield makes a repulsive force against the flange by crushing the rib.

The optical receptacle of the invention has a rear wall with a saddle to mount the neck of the optical subassembly thereof. The metal shield is put between the rear wall and the one of the flanges. The saddle of the rear wall mounts the neck by at least a half of a perimeter of the neck. Thus, because the neck is set on the saddle and the metal shield is put between the rear wall and the flange such that the rib is crushed, the rib causes the repulsive force to the flange to assemble the optical subassembly with the optical receptacle without loose.

The rib may be divided into two portions, and these two portions form the bilateral symmetry with respect to the center of the U-shape. Further, the U-shape cut of the metal shield further has a cut in the center of the U-shape. Thus, the divided ribs may cause the adequate and homogeneous repulsive force against the flange in the right and the left with respect to the axis of the optical subassembly.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is an outer appearance of an optical transceiver according to an embodiment of the present invention;

FIG. 2 is a perspective view of the optical receptacle and the metal shield, where the ROSA and the TOSA are set on respective positions in the optical receptacle;

FIG. 3 shows a state where the ROSA and the TOSA are de-assembled with the optical receptacle;

FIG. 4 is an exploded view of the optical receptacle, the metal shield, the ROSA and the TOSA;

FIG. 5 is a cross section taken along the ling V-V appeared in FIG. 3; and

FIG. 6 is across section taken along the line VI-VI also shown in FIG. 3.

### DETAILED DESCRIPTION OF PREFERRED EMBODIMENTS

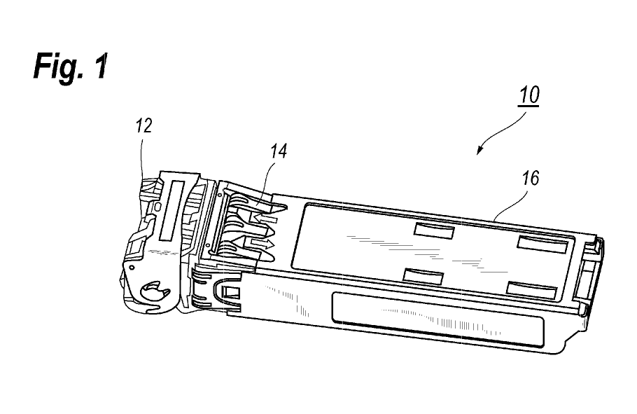

Next, preferred embodiments according to the present invention will be described as referring to accompanying drawings. FIG. 1 is an outer appearance of an optical transceiver according to an embodiment of the present invention. The optical transceiver 10 shown in FIG. 1 may transmit and receive light by being mated with an optical connector which is engaged with the optical receptacle 12.

The optical transceiver 10 includes a transmitter optical subassembly, a receiver optical subassembly, an optical receptacle 12 assembled with the optical connector, and a metal shield 14 that covers the optical receptacle 12. Although not illustrated in FIG. 1, the optical transceiver 10 further provides a circuit board that mounts circuits to be electrically coupled with the TOSA and the ROSA, a frame that mounts the circuit board, and a cover that covers a rear portion of the optical receptacle 12 and fully encloses the circuit board and the frame.

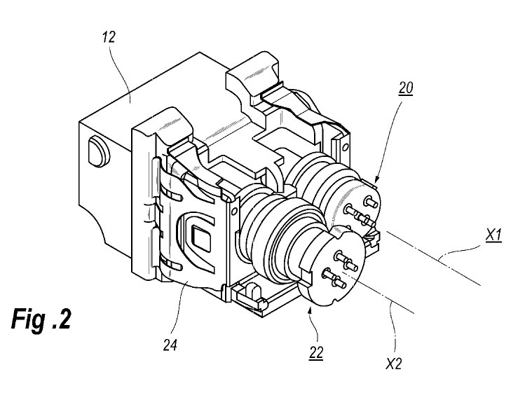

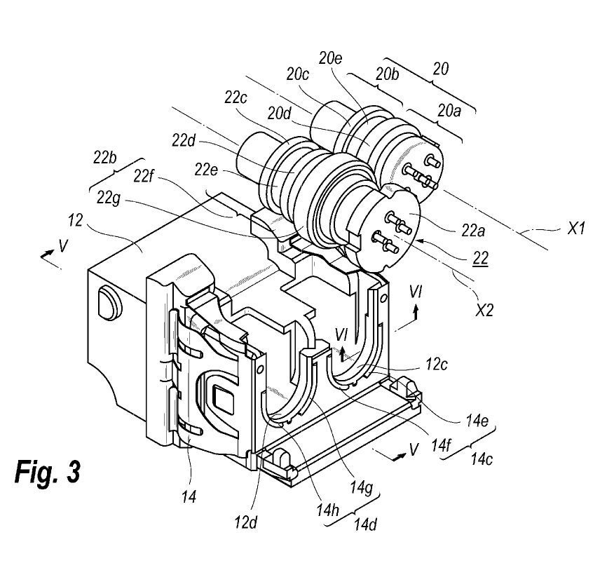

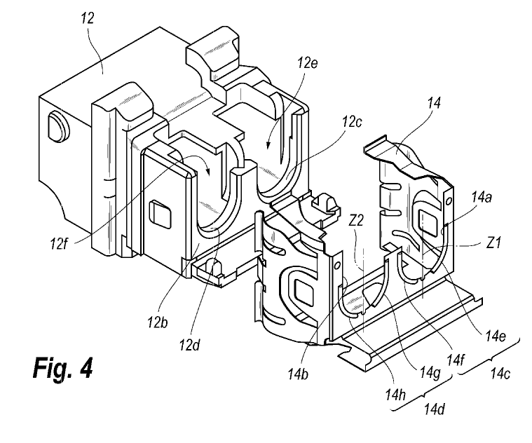

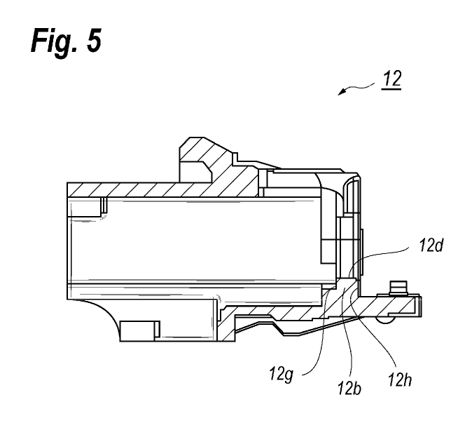

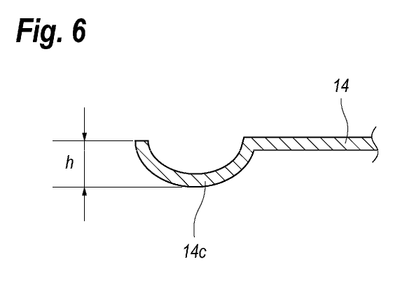

The TOSA, the ROSA, the optical receptacle and the metal shield 14 will be further described. FIG. 2 is a perspective view of the optical receptacle 12 and the metal shield 14, where the ROSA 20 and the TOSA are set on respective positions in the optical receptacle, FIG. 3 shows a state where the ROSA 20 and the TOSA 22 are de-assembled with the optical receptacle 12, and FIG. 4 is an exploded view of the optical receptacle 12, the metal shield 14, the ROSA 20 and the TOSA 22. FIG. 5 is a cross section taken along the line V-V appeared in FIG. 3; while, FIG. 6 is a cross section taken along the line VI-VI also shown in FIG. 3.

The ROSA 20 and the TOSA 22 illustrated in FIG. 2 has a type of, what is called, the CAN package with the co-axial shape. The ROSA 20 has the optical axis X1, while, the TOSA 22 has the optical axis X2. The ROSA 20 installs a light-receiving device, typically a photodiode, to receive signal light provided from the optical connector engaged with the optical receptacle 12. The TOSA 22 installs a light-emitting device, typically a semiconductor laser diode, to transmit light to the optical connector.

The ROSA 20 has the CAN package 20a and a coupling portion 20b. The CAN package 20a installs the photodiode and extends a plurality of lead pins to couple with the circuit on the circuit board. The coupling portion 20b, which has the tubular shape, is attached to the top of the CAN package 20a. The coupling portion 20b may be made of resin and/or metal.

The ROSA 20 provides two flanges, 20c and 20d, arranged along the axis X1 thereof in this order. One of the flange 20c is arranged in outer surface of the coupling portion 20b, while, the other flange 20d is formed in the outer surface of the CAN package 20a. The rear surface of the front flange 20c is perpendicular to the axis X1. Between these two flanges, 20c and 20d, is formed with the neck 20e. The present embodiment shown in FIGS. 2 through 5 provides the neck 20e in the outer surface of the coupling portion 20b.

The TOSA 22 also has the same arrangement with those of the ROSA 20 except for two sleeves, 22f and 22g, in the coupling portion 22b. That is, the TOSA 22 provides two flanges, 22c and 22d, with the neck 22e therebetween. Two flanges, 22c and 22d, and the neck 22e are arranged in the first sleeve 22f, while the second sleeve 22g receives the CAN package 22a. The rear surface of the first flange is perpendicular with the axis X2.

The neck 20e of the ROSA 20 and the neck 22e of the TOSA 22 are arranged in the optical receptacle 12. As illustrated in FIG. 4, the optical receptacle 12 has a rear wall 12b substantially perpendicular to the axes, X1 and X2. The rear wall 12b has two cuts, 12e and 12f, with the U-shape and the bottom of the each cut forms the saddle, 12c and 12d, to mount the neck, 20e and 22e, thereon.

Two cuts, 12e and 12f, continue to the cavity of the optical receptacle 12 where the coupling portion 20b of the ROSA 20 and that 22b of the TOSA set on each saddle, 12b and 12c, engage with the optical connector. Thus, the cavity of the optical receptacle 12 is opened in the front end of the receptacle 12 to receive the optical connector.

The saddle, 12c and 12d, has an inner length corresponding to a half periphery of the neck, 20e and 22e. Specifically, the saddle 12c has a curvature at the bottom thereof greater than a radius of the neck 20e. The other saddle 12d also has a curvature at the bottom thereof greater than the radius of the neck 22e. Thus, the ROSA 20 and the TOSA 22 may be securely mounted on the optical receptacle by the arrangement of the saddles, 12c and 12d, and the necks, 20e and 22e.

The optical receptacle 12c attaches the metal shield 14 thereto. The metal shield 14 is obtained only by cutting and bending a metal sheet so as trace the cross section of the outer wall of the optical receptacle 12. The metal shield 14 may show functions to shield the optical transceiver 10 and to stabilize the ground potential by coming in contact with the ground of the host system.

The metal shield 14 has two cuts, 14a and 14b, each having the U-shape tracing the shape of the saddles, 12c and 12d. Thus, the half opening of the cuts, 14a and 14b, continue with the two cuts, 12e and 12f, of the optical receptacle 12. The cut 14a of the metal shield 14 accompanies with the rib 14c, while the other cut 14b also provides the rib 14d. The rib 14c is divided into two portions, 14e and 14f, by a virtual line Z1 passing the center of the U-shaped cut 14a. The rib 14d is also divided into two ribs, 14g and 14h, by the other virtual line Z2 passing the top of the U-shape of the cut 14b. Thus, two ribs, 14e and 14f, or 14g and 14h, may be preferably formed in bilateral symmetry.

As illustrated in FIG. 6, the ribs, 14c and 14d, have an arched cross section protruding toward the rear side of the optical receptacle so as to abut against the flanges, 20d and 22d, of the ROSA 20 and the TOSA 22. Because the optical receptacle is made of resin molding or metal die-casting, in order to disassemble the cast for forming the saddles, 12c and 12d, of the receptacle 12 in either case, the wall 12b in the width thereof is necessary to be thinner along the direction where the cast will be disassembled. In the present embodiment of the optical receptacle 12, one of the front 12g and the rear surface 12h of the wall 12b must be inclined. However, the front surface 12g of the wall 12b becomes the optical reference plane where the rear surface of the front flange is presses thereat when the optical connector mates with the optical receptacle 12. Then, only the rear surface 12h of the wall 12b may be inclined. But, the inclined rear surface 12h causes a gap between the front surface of the rear flange of the ROSA 20, and that of the TOSA 22, and the rear surface 12h. In the present embodiment, the ribs, 14c and 14d, with the arched cross section may compensate the gap.

The thickness the of the wall 12b in addition to the height h of the ribs, 14c and 14d, along the axis, X1 or X2, is designed to be slightly greater than a width of the neck, 20e and 22e, between respective two flanges, 20c and 20d, or 22c and 22d. Mounting the neck, 20e and 22e, on the saddle, 12c and 12d, and putting the metal shield 14 between the rear surface 12h of the wall 12b and the front surface of the rear flange, 20d and 22d, the rib, 14c and 14d, may elastically deform, which causes a repulsive force to press the rear flange, 20d and 22d, rearward. Thus, the optical transceiver 10 of the present embodiment may assemble the ROSA 20 and the TOSA 22 with the optical receptacle without causing loose.

The rib, 14c and 14d, of the present embodiment may show moderate elasticity by the two part arrangement. Moreover, this two part arrangement has the bilateral symmetry with respect to the center axis, Z1 and Z2, of the U-shape, the repulsive force caused by the deformation of the rib, 14c and 14d, may be equally distributed to the left and right with respect to the axis, X1 and X2.

While there has been illustrated and described what are presently considered to be example embodiments of the present invention, it will be understood by those skilled in the art that various other modifications may be made, and equivalents may be substituted, without departing from the true scope of the invention. For instance, the present embodiment for the TOSA 22 has two sleeves, 22f and 22g; however, the sleeve 22b of the TOSA 22 may have one sleeve as those of the ROSA 20. On the other hand, the ROSA 20 may have two part sleeves as those of the TOSA 22. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. An optical transceiver, comprising:
an optical subassembly having a co-axial CAN package and a sleeve, said sleeve providing a pair of flanges and a neck between said flanges;
an optical receptacle, wherein said optical subassembly is assembled with said optical receptacle; and
a metal shield with a U-shaped cut, wherein said metal shield has a rib formed along said U-shaped cut,
wherein said metal shield is put between one of said flanges and said optical receptacle to make a repulsive force against said one of said flanges by elastically crushing said rib into one of said flanges.

2. The optical transceiver of claim 1,
wherein said optical receptacle has a rear wall with a saddle to mount said neck of said optical subassembly thereon,
wherein said metal shield is put between said rear wall of said optical receptacle and said one of said flanges.

3. The optical transceiver of claim 2,
wherein said saddle mounts said neck by at least a half of a perimeter of said neck.

4. The optical transceiver of claim 1,
wherein said rib has an arched cross section along an optical axis of said optical subassembly.

5. The optical transceiver of claim 1,
wherein said rib is divided into two portions with respect to a center of said U-shape.

6. The optical transceiver of claim 5,
wherein said U-shaped cut has another cut in said center of said U-shape,
wherein said two portions of said rib are formed in bilateral symmetry with respect to said other cut.
